(19) United States
(12) Patent Application Publication
(10) Pub. No.: US 2010/0129592 A1
(43) Pub. Date: May 27, 2010

(54) POLISHING CLOTH AND PRODUCTION METHOD THEREOF

(75) Inventors: Hajime Nishimura, Shiga (JP); Makoto Nishimura, Shiga (JP); Gorou Kondou, Shiga (JP); Echio Kidachi, Shiga (JP)

Correspondence Address: RATNERPRESTIA, P.O. BOX 980, VALLEY FORGE, PA, 19482, US

(73) Assignee: TORAY INDUSTRIES, INC., Tokyo (JP)

(21) Appl. No.: 12/089,165

(22) PCT Filed: Sep. 27, 2006
(86) PCT No.: PCT/JP2006/319101

§ 371 Date: Apr. 3, 2008

(30) Foreign Application Priority Data
Oct. 5, 2005 (JP) JP2005-292019

(51) Int. Cl. D04H 3/16; D06C 11/00; B32B 27/02; D04H 5/02

(52) U.S. Cl. 428/91; 28/103

(57) ABSTRACT

The polishing cloth of the present invention is a polishing cloth, having ultrafine fibers on its surface, of which number average single fiber fineness is 1×10⁻⁸ to 1.4×10⁻³ dtex, and a ratio of fibers in the range of single fiber fineness of 1×10⁻⁸ to 1.4×10⁻³ dtex is 60% or more, characterized in that, intersections between ultrafine fibers of a single fiber fineness of 1×10⁻⁸ to 1.4×10⁻³ dtex exposed on the surface are present at 500 positions or more in average, in 50 positions of 0.01 mm² range observed by using a scanning electron microscope (SEM) at 2000× magnification.

### TECHNICAL FIELD

The present invention relates to a polishing cloth preferably used when an aluminum alloy substrate or a glass substrate used for a magnetic recording disk is subjected to a texture processing with ultra high precision finish, and relates to a polishing cloth having an extremely dense surface condition and an excellent smoothness on which surface nanofibers are dispersed.

### BACKGROUND ART

Recently, in magnetic recording media such as magnetic disks, along with increasing capacity and increasing recording density, flying height of magnetic head is apt to lower significantly. Accordingly, when a protrusion is present on magnetic disk surface, the magnetic head contacts with the protrusion to cause a head crash, and a defect is generated on the disk surface. And, even when it is such a fine protrusion that does not cause a head crash, due to a contact with the magnetic head, it causes an error which occurs at reading or writing of information.

In order to control orientation of crystal growth to improve coercive force of recording direction, when a magnetic metal layer is formed on a disk substrate, a surface treatment called texture processing by which fine streaks are formed on the substrate surface of the recording disk is carried out.

As a method of the texture processing, a slurry grinding in which grinding is carried out by depositing a slurry of loose grains on a polishing cloth surface, or the like is employed. However, in cases where a surface treatment is carried out to satisfy a low flying height of the magnetic head by the texture processing, in order to cope with the increasing recording density to meet the recent rapid increase of recording capacity, it is demanded to achieve a surface roughness of the substrate of 0.3 nm or less and to minimize the defect of the substrate surface which is called as scratch defect, and a polishing cloth capable of coping with the requirement is strongly desired. In the texture processing, various proposals are made that, in order to decrease the surface roughness of the substrate, the fibers constituting the non-woven fabric are made ultra-fine, and in order to minimize the defect of the substrate surface, the non-woven fabric is impregnated with a polymeric elastomer to impart cushioning properties thereto.

For example, a polishing cloth in which an ultrafine fiber non-woven fabric of 0.3 dtex or less is impregnated with a polymeric elastomer is proposed, and a surface roughness of approximately 0.5 nm is achieved (Patent reference 1).

Furthermore, in recent years, by employing a polymer-blend-spinning, a polishing cloth of a non-woven fabric made of a polyamide ultrafine staple fiber of an average fiber fineness of 0.001 to 0.1 dtex (Patent reference 2) is proposed, and a surface roughness of 0.28 nm is achieved in this polishing cloth, but as a further ultrafine fiber, an super ultrafine fiber of a nanofiber level is desired. However, in the conventional island-in-sea-type composite fiber spinning technology, a single fiber fineness in the order of 10⁻³ dtex is the limit, and it is not a level capable of sufficiently coping with the above-mentioned needs.

Furthermore, a method of obtaining a super ultrafine fiber by a polymer blend fiber is disclosed (Patent references 3 and 4), and a super ultrafine fiber of a single fiber fineness in the order of 10⁻⁴ dtex at the finest is obtained. However, the single fiber fineness of the super ultrafine fiber achieved here is determined by dispersing condition of island polymer in the polymer blend fiber, but in the polymer blend system employed in said references, since the dispersion of the island polymer was insufficient, the distribution of single fiber fineness of the obtained super ultrafine fiber was large.

By the way, there is a technique called as electrospinning which is recently highlighted as a technique for making fibers constituting a non-woven fabric ultra-fine. It is a technique in which a polymer is dissolved in an electrolyte solution and extruded from a spinneret, but at that time, a high voltage of several thousands to 30,000 volts is charged to the polymer solution, and the polymer is made ultrafine by a high speed jet of the polymer solution and successive bending and expansion of the jet. By employing this technique, the single fiber fineness can be in the order of 10⁻⁵ dtex (corresponding to single fiber diameter of several tens nm) in some cases which is 1/100 or less in fiber fineness and 1/10 or less in diameter compared to the conventional polymer blend technology. Polymers to be the subject are biopolymers such as a collagen or water soluble polymers in most cases, but in some cases a thermoplastic polymer is subjected to the electrospinning by dissolving it into an organic solvent. However, as described in the book, “Polymer, vol. 40, 4585 (1999)”, strings, which are super ultrafine fiber portions, are mostly connected by beads (0.5 μm diameter), which are puddled portions of the polymer, and there was a large distribution in single fiber fineness in the non-woven fabric, when viewed as a super ultrafine fiber. For that reason, a trial for making the fiber diameter uniform by preventing generation of beads was made, but the distribution is large yet (Non-patent reference 1).

Furthermore, since the non-woven fabric obtainable by the electrospinning is obtained by evaporation of solvent in fiber forming process, its fiber aggregate are not orientation-crystallized in most cases, and its strength is very low compared to ordinary non-woven fabric, to greatly limit its application and development. Furthermore, the electrospinning has a big problem as a producing method, such that a size of the non-woven fabric obtainable is at most approximately 100 cm², and, there is also a problem that its production amount is at most several g/hr which is very low compared to an ordinary melt spinning. Furthermore, there are problems that it needs a high voltage, and the organic solvent or the super ultrafine fiber flies in the air.

Under such a background, recently, as a means for obtaining a super ultrafine fiber of which fiber fineness distribution is small and capable of being stably produced, an artificial leather comprising nanofibers, in which a polymer alloy fiber in which an island component is finely and uniformly dispersed in nano order in a sea component, is used is disclosed (Patent reference 5). The single fiber fineness of said ultrafine fiber is in the order of 10⁻⁵ dtex, and it is a super ultrafine fiber in a level which was conventionally not present, but said ultrafine fiber is almost not dispersed as a nanofiber unit and forms a fiber bundle derived from the polymer alloy fiber before removal of the sea component. Accordingly, property as a bundle becomes dominant, and it could not sufficiently contribute to decrease the surface roughness of substrate or to minimize the scratch defect.

Patent reference 1: JP-2001-1252A

Patent reference 2: JP-2002-273650A

Patent reference 3: JP-H6-272114A

Patent reference 4: JP-3457478B2

Patent reference 5: JP-2004-256983A

Non-patent reference 1: Polymer, vol. 43, 4403 (2002).

### DISCLOSURE OF THE INVENTION

### Problem to be Solved by the Invention

The object of the present invention is to provide a high performance polishing cloth having an extremely dense surface condition and an excellent smoothness, which could not be achieved by conventional ultrafine fibers, by dispersing on surface nanofibers which were very difficult to be dispersed.

### Means for Solving the Problem

In order to solve said problem, the present invention employs the following means. That is,

(1) A polishing cloth, having ultrafine fibers on its surface, of which number average single fiber fineness is 1×10⁻⁸ to 1.4×10⁻³ dtex, and a ratio of fibers in the range of single fiber fineness of 1×10⁻⁸ to 1.4×10⁻³ dtex is 60% or more, characterized in that, intersections between ultrafine fibers of a single fiber fineness of 1×10⁻⁸ to 1.4×10⁻³ dtex exposed on surface are present at 500 places or more in average, in 50 places of 0.01 mm² range observed by using a scanning electron microscope (SEM) at 2000× magnification.

(2) A polishing cloth described in the above-mentioned (1), characterized in that the above-mentioned ultrafine fiber is of a thermoplastic polymer.

(3) A polishing cloth described in the above-mentioned (1) or (2), characterized in that the above-mentioned ultrafine fiber is a condensation polymerization type polymer.

(4) A polishing cloth described in the above-mentioned (3), characterized in that the above-mentioned condensation polymerization type polymer is a polyester or a polyamide.

(5) A polishing cloth described in any one of the above-mentioned (1) to (4), characterized in that it can be obtained from a long fiber nonwoven fabric produced by a spunbond method.

(6) A production method of the polishing cloth described in the above-mentioned (1) to (5), which is a production method of a polishing cloth characterized in that, by using a molten polymer alloy made by combining two kinds or more of polymers with different solubilities in a solvent, a composite fiber web is prepared and after subjected to an entanglement to prepare a non-woven fabric, a polymeric elastomer is imparted to the non-woven fabric, said polymeric elastomer is substantially coagulated to solidify, and after forming raised fibers on surface by subjecting to a raising fiber treatment, ultrafine fiber generation treatment is carried out by dissolving out the easily soluble polymer from said composite fiber.

(7) A production method of a polishing cloth described in the above-mentioned (6), characterized in that a physical action is imparted in liquid during an ultrafine fiber generation processing or after the generation processing.

### Effect of the Invention

According to the present invention, by dispersing, on surface, the nanofibers which were very difficult to be dispersed, it is possible to provide a high performance polishing cloth having an extremely dense surface condition and an excellent smoothness which could not be achieved by conventional ultrafine fibers.

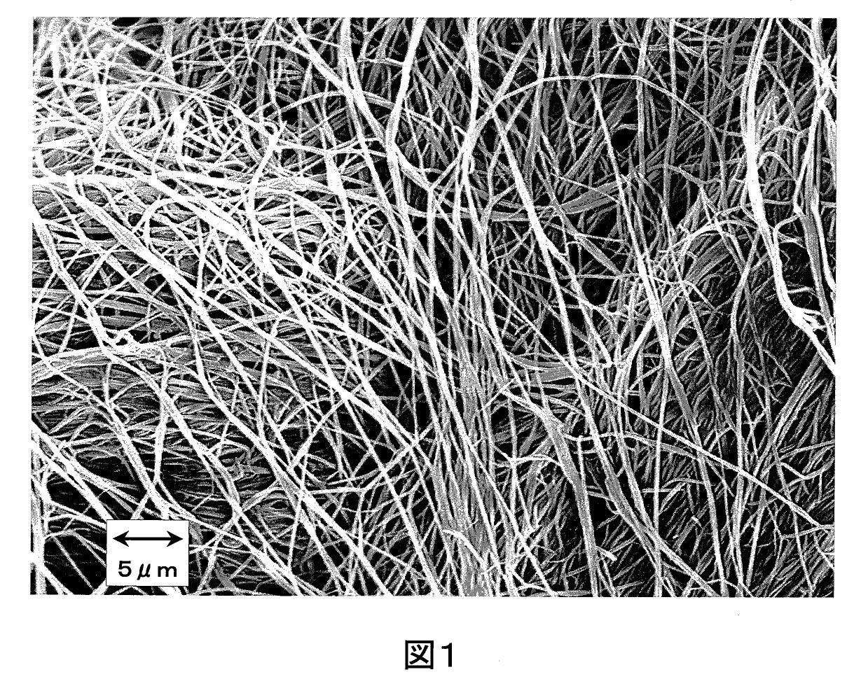

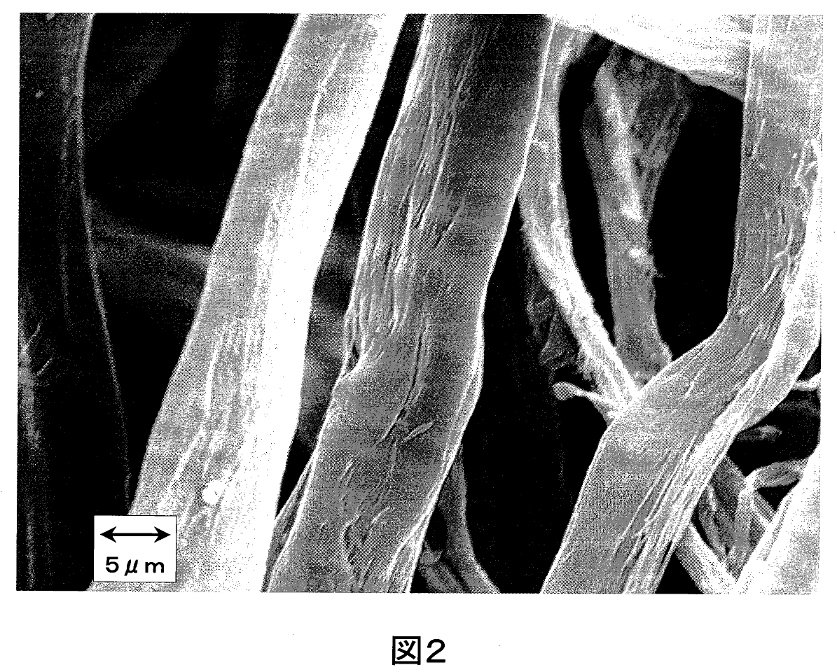

### BRIEF EXPLANATION OF THE DRAWINGS

[FIG. 1] A SEM picture (2000×) which shows an example of surface of a polishing cloth of the present invention.

[FIG. 2] A SEM picture which shows an example of surface of a polishing cloth obtained by a conventional technology (Comparative example 2).

### BEST EMBODIMENT FOR CARRYING OUT THE INVENTION

Hereafter, the present invention is explained in detail with reference to preferable embodiments to carry out.

The polishing cloth of the present invention is a sheet-like material, having ultrafine fibers on its surface, of which number average single fiber fineness is 1 ×10⁻⁸ to 1.4×10−³ dtex, and a ratio of fibers in the range of single fiber fineness of 1×10⁻⁸ to 1.4×10⁻³ dtex is 60% or more, characterized in that, intersections between ultrafine fibers of a single fiber fineness of 1×10⁻⁸ to 1.4×10⁻³ dtex exposed on surface are present at 500 places or more in average, in 50 places of 0.01 mm² range observed by using a scanning electron microscope (SEM) at 2000× magnification. An example of the surface of the polishing cloth of the present invention is shown in FIG. 1.

Here, the ultrafine fiber mentioned in the present invention comprises nanofibers of a single fiber diameter of 1 to 400 nm, and, morphologically, mostly occupied by single fibers dispersed separately, but it is a generic term including all of which single fibers are partly bonded or of which a plural of single fibers aggregates into an assembly, or the like. Its fiber length or cross-sectional configuration, etc., is not limited.

In the present invention, the average value of single fiber fineness of this nanofibers is important. It is determined by observing a cross-section of the polishing cloth comprising ultrafine fibers by a transmission electron microscope (TEM) or a scanning electron microscope (SEM) and measuring single fiber diameters of 50 fibers or more randomly selected in the same cross-section. This observation is repeated in 3 places or more, and it is determined by measuring single fiber diameters of at least 150 fibers or more in total. At this time, except other fibers exceeding equivalent to 400 nm (in case of Nylon 6 (specific gravity 1.14 g/cm³) 1.4×10⁻³ dtex), only single fiber diameters less than that, i.e., in the range of 1 to 400 nm are randomly selected and measured. Furthermore, the range of single fiber fineness is more preferably 1×10⁻⁸ to 6×10⁻⁴ dtex (in case of Nylon 6 it is 1 to 250 nm). Here, the average value of single fiber fineness can be determined by the following method. That is, the fiber finenesses are calculated from single fiber diameters measured and the average value is determined. In the present invention, this is called as “number average single fiber fineness”. In the present invention, it is important that the number average single fiber fineness is 1×10⁻⁸ to 1.4×10⁻³ dtex (equivalent to single fiber diameter of 1 to 400 nm). This is a fineness of 1/10 to 1/1000 compared to the ultrafine fiber obtained by the conventional island-in-sea-type composite fiber spinning, and it is possible to obtain a polishing cloth having a dense surface and a smoothness which could not be obtained by the conventional ultrafine fiber.

Furthermore, distribution of single fiber fineness of the nanofiber constituting the polishing cloth of the present invention is evaluated as follows.

That is, respective single fiber fineness of nanofiber in the polishing cloth is denoted as dtᵢ, and their total is denoted as the total fiber fineness (dt₁+dt₂+ . . . +dtₙ). And, a frequency (number of fibers) of nanofiber having the same single fiber fineness is counted, and its product divided by the total fiber fineness is taken as a fiber fineness ratio of the single fiber fineness. This corresponds to the weight ratio (volume ratio) of the respective single fiber fineness component with respect to the whole nanofiber contained in the non-woven fabric, and a single fiber fineness component of which this value is large greatly contributes to property of the polishing cloth.

Furthermore, in the present invention, distribution of single fiber fineness of such nanofibers, in the same way as the determination of the average value of the above-mentioned single fiber fineness, a cross-section of sheet-like material containing nanofibers at least in a portion is observed by a transmission electron microscope (TEM) or a scanning electron microscope (SEM) and single fiber diameters of nanofiber of 50 fibers or more randomly selected in the same cross-section are measured. And, it is a determination by carrying out this measurement at 3 places or more to measure single fiber diameters of at least 150 fibers or more in total, i.e., it may be determined in the same number of measurements as the determination of the average value of the above-mentioned single fiber fineness.

In the present invention, it is important that 60% or more of the fiber fineness ratio is in the range of 1×10⁻⁸ to 1.4×10⁻³ dtex (equivalent to 1 to 400 nm in single fiber diameter). By this feature, it becomes possible to hold abrasive grains uniformly by sufficiently exhibiting performance of the nanofiber polishing cloth, and it is possible to improve smoothness of the substrate surface of hard disk, and as a result, surface roughness of the substrate is reduced and scratch defects can be decreased significantly. Here, the range of the single fiber fineness is, more preferably, 1×10⁻⁸ to 6×10⁻⁴ dtex (in case of Nylon 6, equivalent to 1 to 250 nm in single fiber diameter).

As the sheet-like material mentioned in the present invention, a staple fiber non-woven fabric which is obtainable by forming a laminate web arranged in transverse direction by using a card and a cross-lapper and then subjecting to a needle punch, or a long fiber nonwoven fabric obtainable by a spunbond or melt-blow method, a non-woven fabric obtainable by a dipping method, a material in which nanofibers are deposited on a substrate by spraying, immersion or coating, a woven or knitted fabric, or the like are preferably used. Among them, a long fiber nonwoven fabric obtainable by the spunbond method is preferable in view of tensile strength, production cost, etc. of the sheet-like material.

In the polishing cloth of the present invention, it is important that intersections between ultrafine fibers of a single fiber fineness of 1×10⁻⁸ to 1.4×10⁻³ dtex exposed on surface are present at 500 places or more in average, in 50 places of 0.01 mm² range observed by using a scanning electron microscope (SEM) at 2000× magnification. Here, dispersibility of surface fibers can be determined by the following way. That is, surface of a polishing cloth containing ultrafine fibers is observed by a SEM and in a picture of the surface taken at an acceleration voltage of 20 kV, a working distance of 8 mm and a magnification of 2000×, a surface area of 0.01 mm² range is randomly selected except apparent defective portions, and intersections between ultrafine fibers of a single fiber fineness of 1×10⁻⁸ to 1.4×10⁻³ dtex (having a single fiber diameter of 1 to 400 nm) exposed on surface are counted. 50 pictures of surface in total are taken, each picture is subjected to the counting, and an average of the 50 places is calculated and rounded off to one place of decimals. At this time, portions where a polymeric elastomer such as polyurethane is exposed and ultrafine fibers are not present or where a big hole is formed by needle punch or the like should be avoided and are not used for the judgment. The intersection between the ultrafine fibers mentioned here is an intersection point where one each of dispersed ultrafine fibers intersects with each other and the acute angle of the intersection angles is 20° or more. A portion where fibers partly confluent, a portion where fibers are parallel without intersection or a portion where fibers are fibrillated is not included. In addition, intersections between bundles, formed by aggregating 2 or more ultrafine fibers, with each other, or intersections between a bundle-like portion and one ultrafine fiber is also not counted. However, intersections between partly dispersed ultrafine fibers on surface of a bundle in which the ultrafine fibers are aggregated in a unit of several hundreds are counted. Here, it is necessary that intersections between the ultrafine fibers in surface area of 0.01 mm² of the polishing cloth containing the ultrafine fibers are present at 500 places or more in average of the 50 pictures, more preferably 1000 places or more. It is because the nanofibers are dispersed on surface and an extremely dense surface condition and an excellent smoothness can be achieved which could not be achieved by conventional ultrafine fibers.

As thermoplastic polymers constituting the polishing cloth of the present invention, polyester or polyamide, polyolefin, polyphenylene sulfide (PPS), etc., are mentioned, but condensation polymerization type polymers represented by polyester or polyamide are more preferable since there are many having a high melting point among them. If the melting point of polymer is 165° C. or more, it is preferable since heat resistance of the ultrafine fiber is good. For example, melting point of PET is 255° C., N6 is 220° C. and polylactic acid (PLA) is 170° C. And, in the polymer, additives such as particles, a flame retarder or an antistatic agent may be contained, or another component may be copolymerized in a range which does not impair property of the polymer.

The nanofiber constituting the polishing cloth of the present invention can be obtained from a polymer alloy fiber. Here, it is preferable that the polymer alloy fiber which is a precursor of the nanofiber is an island-in-sea type fiber obtained by using a molten polymer alloy in which two kinds or more polymers with different solubilities are combined in a solvent. In this polymer alloy fiber, an easily soluble polymer constitutes the sea (matrix) and a hardly soluble polymer constitutes the island (domain), and it is important to control size of the island. Here, the size of island is evaluated by size equivalent to diameter by observing a cross-section of the polymer alloy fiber by a transmission electron microscope (TEM). Since diameter of the nanofiber is mostly determined by the size of island in the precursor, distribution of the size of island is designed depending on diameter distribution of the ultrafine fiber. For that reason, mixing of the polymer to be alloyed is very important, and it is preferable to highly mix by a mixing extruder or a static mixer or the like. However, since mixing is insufficient by a simple chip blend (Patent references 3 and 4), it is difficult to disperse islands in a level of several tens nm.

In concrete, as a measure at carrying out a mixing, although it depends on polymers in combination, it is preferable to use a twin-screw extruding mixer in cases where a mixing extruder is required. In cases where a static mixer is used, it is preferable that the number of divisions is 1,000,000 or more.

In order to circularize the island domain, combination of the polymers becomes also important. It is important that the island component polymer and the sea component polymer are incompatible, but, in a combination of polymers only incompatible, it is difficult that the island component polymer is ultra finely dispersed sufficiently. For that reason, it is preferable to optimaize compatibilities of polymers to be combined, and one index for that purpose is the solubility parameter (SP value). Here, SP value is a parameter which reflects cohesive strength of material defined by (evaporation energy/molar volume)^{1/2}, and it may be possible that a polymer alloy having a good compatibility is obtained with polymers having similar SP values. SP value is known for various polymers, but for example, it is described in “Plastic-Data Book”, coedited by Asahi Kasei Amidas Co., Ltd. and “Plastics” Editorial Department, p189, etc. When the difference of SP values between 2 polymers is 1 to 9 (MJ/m³)^{1/2}, it is preferable since a circularization of the island component by incompatibility and ultrafine dispersion are easy to be compatible. For example, as to Nylon 6 and polyethylene terephthalate, difference of SP values is approximately 6 (MJ/m³)^{1/2} and it is a preferable example, but as to Nylon 6 and polyethylene, difference of SP values is approximately 11 (MJ/m³)^{1/2} and it is mentioned as an example which is not preferable.

Furthermore, melt viscosity is also important and when the melt viscosity of the polymer constituting the island is set lower than that of the sea, the island component polymer is easy to be finely dispersed since the island polymer is easy to deform by a shear force, it is preferable in view of super ultrafining. However, when the viscosity of the island component polymer is made excessively low, it becomes difficult to increase the blend ratio with respect to the whole fiber since the island component apt to be converted into a sea, therefore, it is preferable to control the viscosity of the island component polymer to 1/10 or more of the viscosity of the sea component polymer.

In the ultrafine fiber non-woven fabric used for the polishing cloth of the present invention, in view of reinforcing or improving cushioning properties of the non-woven fabric, other than the nanofiber which constitutes the main component, an ultrafine fiber of single fiber fineness of 1.4×10⁻³ dtex or more of polyamides such as Nylon 6, Nylon 66, Nylon 12 or copolymerized nylon may be used by mixing. However, from the view point of smoothness of the polishing cloth surface, an amount of mixing of, preferably, 30 wt % or less, more preferably, 10 wt % or less with respect to the whole fiber weight is employed.

There is especially no limitation to the polymeric elastomer used in the present invention. For example, polyurethane, polyurea, polyurethane-polyurea elastomer, polyacrylic acid resin, acrylonitrile-butadiene elastomer, styrene-butadiene elastomer or the like can be used. Among them, polyurethane-based elastomers such as polyurethane, polyurethane-polyurea elastomer are preferable.

As to the polyurethane, a polyester-based, polyether-based or polycarbonate-based diol, or a copolymer thereof can be used as polyol component. And, as diisocyanate component, an aromatic diisocyanate, an alicyclic isocyanate, an aliphatic isocyanate or the like can be used.

As the weight average molecular weight of the polyurethane, 50,000 to 300,000 is preferable, more preferably, it is 100,000 to 300,000, still more preferably 150,000 to 250,000. By making the weight average molecular weight to 50,000 or more, it becomes possible to maintain strength of the sheet-like material obtained, and to prevent a falling off of the ultrafine fiber. And, by making it to 300,000 or less, it becomes possible to suppress an increase of viscosity of the polyurethane solution to make an impregnation into the non-woven fabric easy.

As the polymeric elastomer, it is preferable to use a polyurethane as a main component, but in the range of not impairing performance as a binder and uniform dispersion condition of raised fibers, polyester-based, polyamide-based or polyolefin-based elastomer resins or the like, an acrylic resin, an ethylene-vinyl acetate resin, etc., may be contained. Furthermore, as required, additives such as a colorant, an antioxidant, an antistatic agent, a dispersant, a softener, a coagulation controller, a flame retardant, an antimicrobial agent or a deodorant may be compounded.

In the polishing cloth of the present invention, it is preferable that a ratio contained of the polymeric elastomer is, with respect to total weight of fibers of the non-woven fabric, in the range of 5 wt % to 200 wt %. Surface condition, cushioning properties, hardness, strength, etc., of the polishing cloth can be controlled appropriately by the amount contained. When it is 5 wt % or more, falling off of fibers can be decreased and when it is 200 wt % or less, not only processability and productivity are improved, but also it becomes possible to achieve a condition in which ultrafine fibers are uniformly dispersed on its surface. It is preferably in the range of 20 to 100 wt %, more preferably in the range of 30 to 80 wt %.

If there is a dimensional change when a substrate is subjected to a texture processing with the polishing cloth of the present invention in a tape-like state, it is impossible to polish the substrate surface uniformly. Accordingly, from the view point of morphological stability of the polishing cloth, it is preferable that a weight per unit area of the polishing cloth used in the present invention is 100 to 600 g/m² and it is, more preferably, 150 to 300 g/m². And, from the same view point, it is preferable that a thickness of the polishing cloth of the present invention is in the range of 0.1 to 10 mm and, more preferably, it is in the range of 0.3 to 5 mm. Here, a density of the polishing cloth of the present invention is not especially limited, but in order to achieve a uniform processing, it is preferable to be in the range of 0.1 to 1.0 g/cm³.

Furthermore, from the view point of preventing a generation of scratch defect, a processing unevenness caused by an expansion of the tape at the texture processing, in the present invention, it is preferably employed that a reinforcing layer is bonded to opposite surface of the surface having ultrafine fibers of the polishing cloth.

It is preferable, as the reinforcing layer, to use a woven or knitted fabric, a nonwoven fabric made of heat-bondable fiber, or a film-like material. Among them, in order to carry out a precise texture processing, it is more preferable to use a film-like material which is uniform in thickness and physical characteristics.

As materials to be the film mentioned here, those having a film shape such as of a polyolefin-based, a polyester-based and a polyphenyl sulfide-based one can be used. It is preferable to use a polyester film when a general applicability is considered. When a reinforcing layer comprising a film is provided, since it is necessary to satisfy all of morphological stability, cushioning properties and fitting to the substrate surface of the polishing cloth at the texture processing, it is important to make a good thickness balance with the sheet-like material comprising the non-woven fabric. It is preferable that a thickness of the finished sheet-like material comprising the non-woven fabric is 0.4 mm or more, and it is, more preferably, in the range of 0.4 to 1.5 mm from the view point of productivity. For that reason, it is preferable that a thickness of the film is 20 to 100 μm. In cases where the thickness of the sheet-like material comprising the non-woven fabric is less than 0.4 mm, a reinforcing layer is necessary to prevent a dimensional change at the texture processing. On the other hand, it is not preferable that the thickness of the film layer is less than 20 μm, since the dimensional change at the texture processing cannot be prevented, and that it exceeds 100 μm, since a rigidity of the whole polishing cloth becomes to high, and as a result, it is impossible to prevent generating a scratch or the like.

Next, production method of the polishing cloth of the present invention is described in detail.

The polishing cloth of the present invention can be obtained, for example, by combining the following steps. That is, a step in which a composite fiber web is prepared by using a molten polymer alloy in which two kinds or more of polymers with different solubilities are combined in a solvent, and a non-woven fabric is prepared by subjecting the composite fiber web to an entanglement, a step of imparting a polymeric elastomer to said non-woven fabric, and substantially coagulating and solidifying said polymeric elastomer, a step of forming raised fibers on surface by subjecting to a raising treatment, and a step of super ultrafining of the fiber by dissolving out and removing the easily soluble polymer from said composite fiber.

Since it is difficult to produce a non-woven fabric directly from an ultrafine fiber of which number average single fiber fineness is 1×10⁻⁸ to 1.4×10⁻³ dtex, and a ratio of fibers in the range of single fiber fineness of 1×10⁻⁸ to 1.4×10⁻³ dtex is 60% or more, as mentioned above, the steps are taken that, at first, a non-woven fabric is prepared by using a polymer alloy fiber obtained by using a molten polymer alloy in which 2 kinds or more of polymers different in solubility to a solvent are alloyed, and that the ultrafine fibers are generated from this polymer alloy fiber.

The method of obtaining the non-woven fabric constituting the polishing cloth of the present invention is not especially limited, but those obtained by a single component spinning, an island-in-sea type composite spinning, a split type composite spinning or the like can be used. And a long fiber nonwoven fabric directly formed by spinning methods such as spunbond or melt-blow, a non-woven fabric obtainable by a dipping method and a material in which nanofibers are deposited on a substrate by spraying, immersion or coating, a woven or knitted fabric, etc., are preferably used. Among them, a long fiber nonwoven fabric obtainable by a spunbond method is preferable in view of tensile strength, production cost, etc. of the sheet-like material.

The spunbond method is not especially limited, but it is possible to employ a method of making a fiber web by extruding a molten polymer from a nozzle, and after it is suctioned and drawn at a speed of 2500 to 8000 m/min by a high speed suction gas, collecting the fiber on a moving conveyer.

Furthermore, a method of obtaining an integrated sheet by subjecting it to a heat bonding or an entanglement is preferable.

Furthermore, it is also possible to employ a method in which the sea component of the island-in-sea composite fiber is an easily soluble polymer and the island component is a polymer alloy which is a precursor of nanofiber of the present invention, and the easily soluble polymer is dissolved out therefrom.

At this time, as a fiber to be spun, polymer alloy fiber obtained by using a molten polymer alloy in which two kinds or more of polymers with different solubilities are combined in a solvent, i.e., an island-in-sea composite fiber in which the sea component is an easily soluble polymer and the island component is a hardly soluble polymer which is the nanofiber precursor, is used.

A method of entanglement of the fiber'web is not especially limited, but methods such as needle punching or water jet punching can be appropriately combined.

It is preferable that a number of punches of the needle punch is, from the view point of achieving a dense surface condition by a high entanglement of fibers, 1000 to 10000 needles/cm². When it is less than 1000 needles/cm², it is impossible to achieve a predetermined precise finish since surface fiber denseness is poor, and when it exceeds 10000 needles/cm², since not only processability deteriorates but also fiber damage is serious to cause a decrease of strength, it is not preferable. It is preferable that fiber density of the composite fiber non-woven fabric after the needle punch is, from the view point of densification of number of surface fibers, 0.20 g/cm³ or more.

In cases where a water jet punching treatment is carried out, it is preferable to be carried out in a condition that the water is a columnar stream. In order to obtain a columnar stream, usually, a method of ejecting water from a nozzle having a diameter of 0.05 to 1.0 mm at a pressure of 1 to 60 MPa is preferably employed.

It is preferable that the composite fiber non-woven fabric thus obtained is, from the view point of densification, contracted by a dry heat or wet heat or both, to further be densified.

It is preferable that the polishing cloth of the present invention is, before the non-woven fabric comprising the above-mentioned polymer alloy fiber is subjected to an ultrafining treatment, imparted with a polymeric elastomer of which main component is polyurethane. By binder effect of the polymeric elastomer, falling off of the ultrafine fiber from the polishing cloth is prevented, and it becomes possible to uniformly disperse when the ultrafine fiber is exposed on surface.

In addition, for the purpose of loosening adhesion between the fiber and the polymeric elastomer, the fiber may be protected by imparting with polyvinyl alcohol before imparting with the polymeric elastomer.

Polymeric elastomers used are as the above-mentioned, but as solvents used when the polymeric elastomers are imparted, N,N′-dimethyl formamide, dimethyl sulfoxide, etc., can be preferably used. In addition, water-borne polyurethane which is dispersed as an emulsion in water may be used. The polymeric elastomer is imparted to the non-woven fabric such as by immersing the non-woven fabric into a polymeric elastomer solution which is dissolved in a solvent and drying after that, to thereby substantially coagulate and solidify the polymeric elastomer. At the drying, the non-woven fabric and the polymeric elastomer may be heated at a temperature at which their performances are not substantially impaired. It is preferable that an amount of the polymeric elastomer to be imparted in the present invention is, in solid content weight ratio with respect to the ultrafine fiber, in the range of 5 to 200 wt %.

To the polymeric elastomer, as required, a colorant, an antioxidant, an antistatic agent, a dispersant, a softener, a coagulation controller, a flame retardant, an antimicrobial agent, a deodorant or the like may be compounded

In the polishing cloth of the present invention, in order to be the ultrafine fiber in a dispersed condition on surface of the polishing cloth, it is important that the polymer alloy fiber is processed into ultrafine fiber after forming a raised fiber surface comprising the polymer alloy fiber on at least one surface of the sheet-like material comprising the polymer alloy fiber non-woven fabric and the polymeric elastomer. It is because the ultrafining is carried out in a condition in which the raised fiber portion comprising the polymer alloy fiber is dispersed on surface, and it is dispersed on surface in the ultrafining step, and by drying this, it is possible to disperse the ultrafine fiber uniformly such that it covers on surface.

The raised fiber of the polishing cloth of the present invention is obtained by a buffing treatment. In the buffing treatment mentioned here, it is general to carry out by a method of grinding surface by sandpapers, a roll sander or the like. In particular, it is possible to form a uniform and dense raised fiber surface by carrying out a raising fiber treatment by sandpapers. Furthermore, in order to form a uniform raised fiber on surface of the polishing cloth, it is preferable to decrease the load of grinding. In order to decrease the grinding load, it is preferable to appropriately control number of buffing stages, coarseness of sandpaper or the like. Among them, it is more preferable to make number of buffing stage to a multi-stage of 3 stages or more, and coarseness of sandpaper used in each stage to the range of No. 150 to No. 600 prescribed in JIS.

Next, method of developing ultrafine fibers from the raised polymer alloy fiber, i.e., method of generating processing of ultrafine fibers depends on the component to be removed (sea component consisting of the easily soluble polymer). For example, it can preferably be employed to be immersed and squeezed, if the component to be removed is a polyolefin such as PE or polystyrene, in an organic solvent such as toluene or trichloroethylene, and if it is PLA or a copolymerized polyester, in an aqueous alkaline solution such as of sodium hydroxide.

Furthermore, at the ultrafine fiber generating processing, in order to disperse ultrafine fibers on the polishing cloth surface to thereby achieve a densification and smoothness of surface of the polishing cloth of the present invention, it is important to add a physical stimulation in liquid, during the ultrafine fiber generating processing or after the generation processing. The physical stimulation is not especially limited, but a high speed fluid treatments such as water jet punching treatment, crumpling treatment s such as by using Ijet dyeing machine, Wins dyeing machine, Jigger dyeing machine, tumbler, relaxer or the like, and ultra-sonic treatment, etc., may be employed appropriately in combination.

In order to obtain an increase of strength and dimensional stability of the polishing cloth of the present invention in wet condition, before or after the ultrafine fiber generating processing, wet heat or dry heat treatment, or both may be carried out. The wet heat treatment of the present invention is not especially limited, for example, known treating apparatuses such as a jet dyeing machine, a continuous steamer, a Jigger dyeing machine, a beam dyeing machine can be used. The method of dry heat treatment is also not especially limited, for example, known methods used in ordinary process such as a conveyor type drier, a pin tenter, a clip tenter, a calender can be applied.

As methods for bonding the reinforcing layer to the polishing cloth of the present invention, any method of a heat press method, a flame lamination method, a method of providing an adhesive layer between the reinforcing layer and the sheet-like material, may be employed. As the adhesive layer, those having a rubber elasticity such as polyurethane, styrene-butadiene rubber (SBR), nitrile-butadiene (NBR), polyamino acid and acrylic-based adhesive can be used. When cost or practical applicability is considered, adhesives such as NBR or SBR are preferable. As a method for imparting the adhesive, a coating to the sheet-like material in an emulsion or latex condition is preferably employed.

As method for carrying out the texture processing to the polishing cloth of the present invention, from the view point of processing efficiency and stability, said polishing cloth is cut into a tape state of 30 to 50 mm width and used as a tape for texture processing.

A method of carrying out a texture processing of aluminum alloy magnetic recording disk by using said polishing tape and a slurry containing loose grains is a preferable method. As the polishing condition, a slurry in which high hardness abrasive grains such as diamond are dispersed in an aqueous dispersion medium is preferably used.

From the view points of grain retention ability and dispersibility, as a grain size suitable for the ultrafine fiber constituting the polishing cloth of the present invention, 0.2 μm or less is preferable.

### EXAMPLES

Hereafter, the present invention is explained in more detail with reference to examples, but the present invention is not limited thereto. In addition, evaluation methods and measuring conditions employed in the examples are explained hereafter.

(1) Melt Viscosity of Polymer

Melt viscosity of polymer was measured by Capirograph 1B produced by Toyo Seiki Seisaku-sho, Ltd. Here, the storage time of the polymer from feeding sample to start of measurement is set to 10 minutes.

(2) Melting Point

By using DSC-7 produced by Perkin Elmer Inc., a peak top temperature in 2nd run which indicates polymer melting was taken as the melting point. At this time, a temperature raising speed was set to 16° C./min and an amount of sample was set to 10 mg.

(3) Observation of Cross-Section of Sheet-Like Material (Polishing Cloth) by TEM

A sheet-like material (polishing cloth) was embedded with an epoxy resin, an ultrathin section was cut out in cross-sectional direction and the cross-section of the sheet-like material (polishing cloth) was observed by a transmission electron microscope (TEM). In addition, as required, it is subjected to metal coloring.

TEM instrument: H-7100FA type produced by Hitachi, Ltd.

(4) Number average single fiber fineness and diameter of ultrafine fiber A cross-section of the sheet-like material comprising the ultrafine fibers (polishing cloth) is observed by a transmission electron microscope (TEM) or a scanning electron microscope (SEM), and single fiber diameters of 50 fibers or more randomly selected in a same cross-section are measured. In the measurement, the single fiber diameter and the fiber fineness are determined from the cross-sectional picture of TEM or SEM of the sheet-like material (polishing cloth) by using an image processing software (WINROOF), and this procedure is carried out at 3 places or more to thereby measure single fiber diameters of at least 150 fibers or more. At this time, except other fibers exceeding 400 nm (1.4×10⁻³ dtex in case of Nylon 6 (specific gravity 1.14 g/cm³)), only fibers of single fiber diameter of 1 to 400 nm are randomly selected and measured. Here, when the nanofiber constituting the sheet-like material (polishing cloth) has a non-circular cross section, the single fiber cross-sectional area is measured at first, and said area is taken as a hypothetical area in case of circular cross-section. The single fiber diameter is determined by calculating a diameter from the area. The average value of the single fiber fineness is determined in the following way. At first, single fiber diameter is measured in nm unit to one place of decimals, and the number after the decimal point is round off. A single fiber fineness is calculated from the single fiber diameter, and a simple average value is determined. In the present invention, this is taken as “number average single fiber fineness”.

Number average single fiber diameter and single fiber fineness are also determined by the same statistical means.

SEM instrument: VE-7800 type produced by Keyence Corp.

(5) Number Average Single Fiber Fineness Distribution (the Fiber Fineness Ratio) of Nanofiber

A single fiber fineness distribution of the nanofiber constituting the polishing cloth is, as described before, evaluated in the following way. That is, respective single fiber finenesses of nanofiber in the polishing cloth are determined to one significant figure, said value is denoted as dti and their total is denoted as the total fiber fineness (dt₁+dt₂+ . . . dtₙ). And, a frequency (number of fibers) of nanofiber having a same single fiber fineness which was determined above to one significant figure is counted, and its product divided by the total fiber fineness is taken as a fiber fineness ratio of the single fiber fineness. This corresponds to the weight ratio (volume ratio) of the respective single fiber fineness component with respect to the whole nanofiber contained in the polishing cloth, and a single fiber fineness component of which this value is large greatly contributes to property of the polishing cloth.

Furthermore, in the present invention, distribution of single fiber fineness of said nanofiber is determined, in the same way as the determination of the average value of the above-mentioned single fiber fineness, i.e., a cross-section of sheet-like material (polishing cloth) containing nanofibers at least in a portion is observed by a transmission electron microscope (TEM) or a scanning electron microscope (SEM) and single fiber diameters of nanofiber of 50 fibers or more randomly selected in the same cross-section are measured, but this is carried out at 3 places or more to measure single fiber diameters of at least 150 fibers or more in total, i.e., it is determined in the same number of measurements as the determination of the average value of the above-mentioned single fiber fineness.

(6) Dispersibility of Ultrafine Fiber (Number of Intersections)

Surface of a sheet-like material (polishing cloth) comprising ultrafine fibers is observed by VE-7800 type SEM produced by Keyence Corp. and in a picture of the surface taken at an acceleration voltage of 20 kV, a working distance of 8 mm and a magnification of 2000×, a surface area of 0.01 mm² range is randomly selected except apparent defective portions, and intersections between the ultrafine fibers having a single fiber diameter of 1 to 400 nm exposed on the surface of the sheet-like material (polishing cloth) are counted. 50 or more surface pictures in total are taken, each picture is subjected to the counting, and an average value of the 50 places is calculated and rounded off to one place of decimals. At this time, portions where a polymeric elastomer such as polyurethane is exposed and ultrafine fibers are not present or where a big hole is formed by a needle punch or the like should be avoided and are not used for the judgment. The intersection between the ultrafine fibers mentioned here is an intersection point where one each of dispersed ultrafine fibers intersects with each other and the acute angle of the intersection angles is 20° or more. A portion where fibers partly confluent, a portion where fibers are parallel without intersection or a portion where fibers are fibrillated is not included. In addition, intersections between bundles, formed by aggregating 20° or more ultrafine fibers, with each other, or intersections between a bundle-like portion and one ultrafine fiber is also not counted. However, intersections between partly dispersed ultrafine fibers on surface of a bundle in which the ultrafine fibers are aggregated in a unit of several hundreds are counted. A case where intersections between the ultrafine fibers in surface area of 0.01 mm² of the sheet-like material (polishing cloth) containing the ultrafine fibers are present at 500 places or more in average is evaluated as good in dispersibility.

(7) Surface Roughness of Substrate

Average roughnesses are measured in 10 places, arbitrarily selected, on surface of a disk substrate sample after a texture processing in accordance with JIS B0601 (2001edition), by using TMS-2000 surface roughness measuring instrument produced by Schmitt Measurement Systems, Inc., and a surface roughness of the substrate is calculated by averaging the measured data of the 10 places. As the value becomes smaller, it is indicated that the performance is higher.

(8) Number of Scratches

As to whole area of both surfaces of 5 substrates after a texture processing, i.e., 10 surfaces in total as objects to be measured, number of scratches was measured by taking a groove of depth of 3 nm or more as a scratch by using Candela 5100 surface photoanalyzer, and it is evaluated by average value of the 10 surfaces. As the value becomes smaller, it is indicated that the performance is higher.

### Example 1

Polymer alloy chips were obtained by mixing N6 (40 wt %) of a melt viscosity of 310 poise (240° C., shear rate 121.6 sec⁻¹) and a melting point of 220° C. and polylactic acid (PLA) (optical purity 99.5% or more) (60 wt %) of a weight average molecular weight of 120,000, a melt viscosity of 720 poise (240° C., shear rate 121.6 sec⁻¹) and a melting point of 170° C., by a twin screw extruding mixer at 220° C. Here, weight average molecular weight of the PLA was determined by the following way. That is, tetrahydrofuran was mixed to chloroform solution of a sample to prepare a solution to be measured. This is subjected to a measurement by using a gel permeation chromatograph (GPC), Waters 2690 produced by Waters Corp., at 25° C., and a weight average molecular weight in polystyrene equivalent was determined. The measurements were carried out at three points in each sample and their average value was taken as a weight average molecular weight.

By a spunbond method, after the above-mentioned polymer alloy chips were extruded from fine holes at a spinning temperature of 240° C., spun at a spinning speed of 4500 m/min by an ejector, collected on a moving net conveyor, heat press bonded by emboss rolls of a press bond ratio of 16% under a condition of a temperature of 80° C. and a linear pressure of 20 kg/cm, and obtained a long fiber nonwoven fabric of a single fiber fineness 2.0 dtex and a weight of 150 g/m².

The non-woven fabric consisting of said polymer alloy fibers was imparted with an oil agent (SM7060EX produced by Toray Dow Corning Silicone Co. Ltd.) in an amount of 2 wt % with respect to the fiber weight, 4 sheets of them were superposed, and by subjecting it to a needle punch of 5000 needles/cm² by using a needle with one barb of a depth of 0.06 mm, a non-woven fabric of a weight of 658 g/m² consisting of the polymer alloy fiber was obtained.

This non-woven fabric was imparted with 20 wt % polyvinyl alcohol in solid content with respect to the polymer alloy fiber weight by impregnating with a polyvinyl alcohol solution of a liquid temperature of approximately 85° C. and of a concentration of approximately 12% and squeezing by nip rolls, and dried. Next, it was imparted with 20 wt % polyurethane in solid content with respect to the fiber weight by impregnating with DMF solution of a polyester polyether-based polyurethane of a concentration of approximately 12% and squeezing by nip rolls, and the polyurethane was coagulated by a 30% aqueous solution of DMF of a liquid temperature of 35° C., and the DMF and polyvinyl alcohol were removed by a hot water of approximately 85° C. After that, the surface was buffed by sandpapers of JIS #180 to form raised fibers.

Finally, by a jet dyeing machine (Uniace FLR type), by using a nozzle of 80 mm, at a bath ratio of 1/27, it was treated with 4% aqueous solution of sodium hydroxide of 80° C. for 30 minutes and thereafter washed with water 4 times and dried to thereby dissolve out PLA which is the sea component and generate ultrafine fibers consisting of N6. As a result of analyzing the N6 only in this sheet-like material from a TEM picture, the number average single fiber diameter of N6 was 94 nm (7.9×10⁻³ dtex). And, the fiber fineness ratio of single fiber fineness of 1×10⁻⁸ to 1.4×10⁻³ dtex was 99%. Furthermore, in the examples mentioned hereafter, the fiber fineness ratio was determined based on the same range.

By subjecting it to a crumpling treatment in the jet dyeing machine in said dissolving out process, the polishing cloth was imparted with a physical action, and the ultrafine fibers were dispersed on the polishing cloth surface.

Intersections between the ultrafine fibers were counted by a SEM picture magnified at 2000×, and it was found to be present at 1295 places in average in surface area of 0.01 mm², thus, dispersibility was good.

Said polishing cloth was made into a tape of 40 mm width, and a texture processing was carried out under the following conditions.

By using a disk of which aluminum substrate had been subjected to a Ni—P plating and then subjected to a polishing processing to adjust to an average surface roughness of 0.2 nm, a polishing was carried out for 10 seconds under a condition of a tape running speed of 5 cm/min while dropping on the polishing cloth surface a loose grain slurry comprising a diamond crystal of a primary particle size of 1 to 10 nm.

The disk after the texture processing had a surface roughness of 0.12 nm and a number of scratches of 15 and it was a processed surface on which dense and uniform texture traces were formed, and the processability was also good.

### Example 2

Polymer alloy chips were obtained by mixing PBT (20 wt %) of a melt viscosity 1200 poise (262° C., shear rate 121.6 sec⁻¹), melting point of 225° C., and polylactic acid (PLA) (optical purity 99.5% or more) (80 wt %) of a weight average molecular weight of 120,000, a melt viscosity of 300 poise (240° C., shear rate 121.6 sec⁻¹) and a melting point of 170° C. by a twin screw extruding mixer at 250° C.

By a spunbond method, after the above-mentioned polymer alloy chips were extruded from fine holes at a spinning temperature of 250° C., spun at a spinning speed of 4000 m/min by an ejector, collected on a moving net conveyor, heat press bonded by emboss rolls of a press bond ratio of 16% under a condition of a temperature of 90° C. and a linear pressure of 20 kg/cm, and obtained a long fiber nonwoven fabric of a single fiber fineness 2.0 dtex and a weight of 150 g/m².

The non-woven fabric consisting of said polymer alloy fibers was imparted with an oil agent (SM7060EX produced by Toray Dow Corning Silicone Co. Ltd.) in an amount of 2 wt % with respect to the fiber weight, 4 sheets of them were superposed, and by subjecting it to a needle punch of 5000 needles/cm² by using a needle with one barb of a depth of 0.06 mm, a non-woven fabric of a weight of 648 g/m² consisting of the polymer alloy fiber was obtained.

This non-woven fabric was imparted with 20 wt % polyvinyl alcohol in solid content with respect to the polymer alloy fiber weight by impregnating with a polyvinyl alcohol solution of a liquid temperature of approximately 85° C. and a concentration of approximately 12% and squeezing by nip rolls, and dried. Next, it was imparted with 18 wt % polyurethane in solid content with respect to the fiber weight by impregnating with DMF solution of a polyester-polyether-based polyurethane of a concentration of approximately 11% and squeezing by nip rolls, and the polyurethane was coagulated by 30% aqueous solution of DMF of a liquid temperature of 35° C., and the DMF and polyvinyl alcohol were removed by hot water of approximately 85° C. After that, the surface was buffed by sandpapers in the same way as Example 1 to form raised fibers.

Finally, in the same way as Example 1, it was treated with 4% aqueous solution of sodium hydroxide of 80° C. for 30 minutes and dried to dissolve out PLA which is the sea component, to thereby generate ultrafine fibers consisting of N6. As a result of analyzing the N6 only in this sheet-like material from a TEM picture, the number average single fiber diameter of PBT was 86 nm (7.6×10⁻⁵ dtex). And, the fiber fineness ratio of single fiber fineness of 1×10⁻⁸ to 1.4×10⁻³ dtex was 99%.

By subjecting it to a crumpling treatment in the jet dyeing machine in said dissolving out process, the polishing cloth was imparted with a physical action, and the ultrafine fibers were dispersed on the polishing cloth surface.

Intersections between the ultrafine fibers were counted by a SEM picture magnified at 2000×, and it was found to be present at 1513 places in average in surface area of 0.01 mm², thus, dispersibility was good.

By using said polishing cloth, a texture processing was carried out in the same way as Example 1.

The disk after the texture processing had a surface roughness of 0.17 nm and a number of scratches of 30, and the processability was also good.

### Example 3

Polymer alloy chips were obtained by mixing N6 (20 wt %) of a melt viscosity 530 poise (262° C., shear rate 121.6 sec⁻¹) and a melting point of 220° C., and a copolymerized PET (80 wt %), in which isophthalic acid 8 mol % and bisphenol A 4 mol % were copolymerized, of a melting point of 225° C. by a twin screw extruding mixer at 260° C.

By using this polymer alloy chips and by employing the known method described in example 1 of JP-2004-162244A, a drawn yarn which is drawn at a draw ratio of 3.2 of 120 dtex and 12 filaments was obtained.

This polymer alloy fibers were crimped and cut into a number of crimps of 14 crimps/2.54 cm and a cut length of 51 mm to obtain a polymer alloystaple fiber. The obtained polymer alloy staple fiber was subjected to a carding and a cross-lapping to prepare a web, and then, subjected to a needle punch of 3000 needles/cm², to obtain a non-woven fabric consisting of the polymer alloy staple fiber of a weight of 610 g/m².

This non-woven fabric was imparted with 20 wt % polyvinyl alcohol in solid content with respect to the fiber weight by impregnating with a polyvinyl alcohol solution of a liquid temperature of approximately 85° C. and a concentration of approximately 12% and squeezing by nip rolls, and dried. Next, it was imparted with 14 wt% polyurethane in solid content with respect to the fiber weight by impregnating with DMF solution of a polyester polyether-based polyurethane of a concentration of approximately 10% and squeezing by nip rolls, and the polyurethane was coagulated by a 30% aqueous solution of DMF of a liquid temperature of 35° C., and the DMF and polyvinyl alcohol were removed by hot water of approximately 85° C. After that, the surface was buffed by sandpapers in the same way as Example 1 to form raised fibers.

Finally, in the same way as Example 1, it was treated with 4% aqueous solution of sodium hydroxide of 80° C. for 30 minutes and dried to dissolve out PLA which is the sea component, to thereby generate ultrafine fibers consisting of N6. As a result of analyzing the N6 only in this sheet-like material from a TEM picture, the number average single fiber diameter of N6 was 58 nm (3.0×10⁻⁵ dtex). And, the fiber fineness ratio of single fiber fineness of 1×10⁻⁸ to 1.4×10⁻³ dtex was 99%.

By subjecting it to a crumpling treatment in the jet dyeing machine in said dissolving out process, the polishing cloth was imparted with a physical action, and the ultrafine fibers were dispersed on the polishing cloth surface.

Intersections between the ultrafine fibers were counted by a SEM picture magnified at 2000×, and it was found to be present at 1621 places in average in surface area of 0.01 mm², thus, dispersibility was good.

By using said polishing cloth, a texture processing was carried out in the same way as Example 1.

The disk after the texture processing had a surface roughness of 0.14 nm and a number of scratches of 20, and the processability was also good.

### Example 4

A laminate sheet-like material comprising a nanofiber polishing cloth and a polyester film was obtained by coating an adhesive of which main component is NBR (nitrile rubber) to the reverse surface of the polishing cloth obtained in Example 1 and press bonding thereto a polyester film of a thickness of 50 μm.

By using said polishing cloth, a texture processing was carried out in the same way as Example 1.

Since an unevenness due to an extension of the polishing cloth was prevented, the disk after the texture processing had a surface roughness of 0.11 nm and a number of scratches of 10, and the processability was very good.

### Example 5

By using a staple fiber of an island-in-sea type composite fiber of which island component is the polymer alloy chips of N6/PLA=40/60 used in Example 1, sea component is polystyrene copolymerized with 22% of 2-ethyl hexyl acrylate, island/sea weight ratio=80/20 wt %, number of islands is 36 islands, composite single fiber fineness is 3.5 dtex, cut length is approximately 51 mm and number of crimps is 14 crimps/2.54 cm, a web was prepared through card and crosslapper processes, and then, it was subjected to a needle punch of 3000 needles/cm² by the needle used in Example 1 to thereby prepare a felt having a weight of 700 g/m².

This felt was imparted with 20 wt % polyvinyl alcohol in solid content with respect to the island (polymer alloy) component by impregnating with a polyvinyl alcohol solution of a liquid temperature of approximately 85° C. and a concentration of approximately 12% and squeezing by nip rolls, and dried. After that, the sea component (copolymerized polystyrene) was removed by 30° C. trichloroethylene and a nonwoven fabric consisting of ultrafine fibers of a single fiber fineness of approximately 0.08 dtex was obtained.

This nonwoven fabric was impregnated with DMF solution of a polyester polyether-based polyurethane and squeezed by nip rolls to impart with 18 wt % polyurethane in solid content with respect to the fiber weight, and the polyurethane was coagulated by a 30% aqueous solution of DMF of a liquid temperature of 35° C., and the DMF and polyvinyl alcohol were removed by hot water of approximately 85° C. Next, the surface was buffed by sandpapers in the same way as Example 1 to form raised fibers.

Finally, in the same way as Example 1, it was treated with 4% aqueous solution of sodium hydroxide of 80° C. for 30 minutes and dried to dissolve out PLA from the polymer alloy, thereby generating ultrafine fibers consisting of N6. As a result of analyzing the N6 only in this polishing cloth from a TEM picture, the number average single fiber diameter of N6 was 320 nm (9.2×10⁻⁴ dtex), and, the fiber fineness ratio of single fiber fineness of 1×10⁻⁸ to 1.4×10⁻³ dtex was 65%.

By subjecting it to a crumpling treatment in the jet dyeing machine in said dissolving out process, the polishing cloth was imparted with a physical action, and the ultrafine fibers were dispersed on the polishing cloth surface.

Intersections between the ultrafine fibers were counted by a SEM picture magnified at 2000×, and it was found to be present at 1589 places in average in surface area of 0.01 mm², thus, dispersibility was good.

By using said polishing cloth, a texture processing was carried out in the same way as Example 1. The disk after the texture processing had a surface roughness of 0.18 nm and a number of scratches of 42, and the processability was very good.

### Example 6

Polymer alloy chips were obtained by mixing PBT (40 wt %) of a melt viscosity 1200 poise (262° C., shear rate 121.6 sec⁻¹) and a melting point of 225° C., and polylactic acid (PLA) (optical purity 99.5% or more) (60 wt %) of a weight average molecular weight 120,000, a melt viscosity of 300 poise (262° C., shear rate 121.6 sec⁻¹) and a melting point of 170° C., by a twin screw extruding mixer at 250° C.

By using a staple fiber of an island-in-sea type composite fiber of which island component is the above-mentioned polymer alloy chip, sea component is copolymerized polystyrene used in Example 5, island/sea ratio=80/20 wt %, number of islands is 36 islands, composite single fiber fineness is 3.5 dtex, cut length is approximately 51 mm and number of crimps is 14 crimps/2.54 cm, a web was prepared through card and crosslapper processes, and then, it was subjected to a needle punch of 3000 needles/cm² by the needle used in Example 1 to thereby prepare a felt having a weight of 700 g/m².

This felt was imparted with 20 wt % polyvinyl alcohol in solid content with respect to the island (polymer alloy) component by impregnating with a polyvinyl alcohol solution of a liquid temperature of approximately 85° C. and a concentration of approximately 12% and squeezing by nip rolls, and dried. After that, the sea component (copolymerized polystyrene) was removed by 30° C. trichloroethylene and a nonwoven fabric consisting of ultrafine fibers of a single fiber fineness of approximately 0.08 dtex was obtained.

This nonwoven fabric was impregnated with DMF solution of a polyester-polyether-based polyurethane and squeezed by nip rolls to impart with 19 wt % polyurethane in solid content with respect to the fiber weight, and the polyurethane was coagulated by a 30% aqueous solution of DMF of a liquid temperature of 35° C., and the DMF and polyvinyl alcohol were removed by hot water of approximately 85° C. After that, the surface was buffed by sandpapers in the same way as Example 1 to form raised fibers.

After forming the raised fibers, in the same way as Example 1, it was treated with 4% aqueous solution of sodium hydroxide of 80° C. for 30 minutes and dried to dissolve out PLA from the polymer alloy, thereby generating ultrafine fibers consisting of N6. As a result of analyzing the PBT only in this polishing cloth from a TEM picture, the number average single fiber diameter of the PBT was 290 nm (8.6×10⁻⁴ dtex), and, the fiber fineness ratio of single fiber fineness of 1×10⁻⁸ to 1.4×10⁻³ dtex was 68%.

By subjecting it to a crumpling treatment in the jet dyeing machine in said dissolving out process, the polishing cloth was imparted with a physical action, and the ultrafine fibers were dispersed on the polishing cloth surface.

Intersections between the ultrafine fibers were counted by a SEM picture magnified at 2000x, and it was found to be present at 1690 places in average in surface area of 0.01 mm², thus, dispersibility was good.

By using said polishing cloth, a texture processing was carried out in the same way as Example 1. The disk after the texture processing had a surface roughness of 0.20 nm and a number of scratches of 64, and the processability was very good.

### Example 7

A polishing cloth was obtained in the same way as Example 1 except carrying out a wet heat treatment at 125° C. for 20 minutes after dissolving out PLA by the jet dyeing machine in the ultrafine fiber generating processing. As a result of analyzing the N6 only in this polishing cloth from a TEM picture, the number average single fiber diameter of the N6 was 125 nm (1.4×10⁻⁴ dtex), and, the fiber fineness ratio of single fiber fineness of 1×10⁻⁸ to 1.4×10⁻³ dtex was 99%.

By subjecting it to a crumpling treatment in the jet dyeing machine in said dissolving out process, the polishing cloth was imparted with a physical action, and the ultrafine fibers were dispersed on the polishing cloth surface.

Intersections between the ultrafine fibers were counted by a SEM picture magnified at 2000×, and it was found to be present at 1053 places in average in surface area of 0.01 mm², thus, dispersibility was good.

By using said polishing cloth, a texture processing was carried out in the same way as Example 1. By the wet heat treatment, dimensional stability of the polishing cloth was improved and the disk after the texture processing had a surface roughness of 0.11 nm and a number of scratches of 13, and the processability was very good.

Characteristics of the obtained polishing cloth are as shown in Table 2, but every of the intersections between the ultrafine fibers in surface area of 0.01 mm² observed from SEM pictures magnified at 2000× of the polishing clothes of Examples 1 to 7, was 500 places or more in average, and the dispersibility was good. Furthermore, hard disks on which a magnetic layer is formed after the texture processing were excellent in both of surface roughness of the substrate and number of scratches in hard disk drive test.

### Comparative Example 1

In the same way as Example 1, by using the N6/PLA=40/60 polymer alloy chips, after it was spun and made into a sheet by spunbond method, superposed by needle punch, and a polymer alloy non-woven fabric having a weight of 610 g/m² was obtained. This nonwoven fabric was imparted with 20 wt % polyvinyl alcohol in solid content with respect to the polymer alloy fiber weight by impregnating with a polyvinyl alcohol solution of a liquid temperature of approximately 85° C. and a concentration of approximately 12% and squeezing by nip rolls, and dried. After that, it was impregnated with DMF solution of a polyester polyether-based polyurethane of a concentration of approximately 12% and squeezed by nip rolls to impart with 20 wt % polyurethane in solid content with respect to the fiber weight, and the polyurethane was coagulated by a 30% aqueous solution of DMF of a liquid temperature of 35° C., and the DMF and polyvinyl alcohol were removed by hot water of approximately 85° C.

Next, in the same way as Example 1, it was treated with 4% aqueous solution of sodium hydroxide of 80° C. for 30 minutes and dried to dissolve out PLA which is the sea component, to thereby generate ultrafine fibers consisting of N6. As a result of analyzing the N6 only in this sheet-like material from a TEM picture, the number average single fiber diameter of N6 was 94 nm (7.9×10⁻⁵ dtex).

Finally, the surface was buffed by sandpapers in the same way as Example 1, but since the ultrafine fibers on the surface were aggregated in a bundle state, they did not disperse and it was a coarse surface.

Intersections between the ultrafine fibers were counted by a SEM picture magnified at 2000×, and it was found to be present at 134 places in average in surface area of 0.01 mm², thus, dispersibility was poor.

By using said polishing cloth, a texture processing was carried out in the same way as Example 1. The disk after the texture processing had a surface roughness of 0.22 nm and a number of scratches was 105. And, when the whole texture processed surface was observed, surface undulation was large and uniformity of texture traces was insufficient.

### Comparative Example 2

In the same way as Example 3, by using the polymer alloy chip of N6/copolymerized PET=20/80, a polymer alloy non-woven fabric, consisting of a staple fiber of 120 dtex, 12 filaments, having a weight of 610 g/m² was obtained.

This non-woven fabric was shrunk by a hot water of approximately 95° C. After that, in the same way as Example 1, it is treated with an aqueous solution of 4% sodium hydroxide at 80° C. for 30 minutes, and dried to thereby dissolve out PLA which is the sea component, and ultrafine fibers consisting of N6 were generated. As a result of analyzing the N6 only in this non-woven fabric from a TEM picture, number average single fiber diameter of N6 was 58 nm (3.0×10⁻⁵ dtex). This nonwoven fabric was impregnated with DMF solution of a polyester-polyether-based polyurethane of a concentration of approximately 12% and squeezed by nip rolls to impart with 21 wt % polyurethane with respect to the fiber weight, and the polyurethane was coagulated by a 30% aqueous solution of DMF of a liquid temperature of 35° C., and the DMF was removed by hot water of approximately 85° C. After that, the surface was buffed by sandpapers in the same way as Example 1 to form raised fibers. Most of the ultrafine fibers on surface were in bundle state and they were not dispersed in ultrafine fiber unit.

Intersections between the ultrafine fibers were counted by a SEM picture magnified at 2000×, and it was found to be present at 142 places in average in surface area of 0.01 mm², thus, dispersibility was poor.

By using said polishing cloth, a texture processing was carried out in the same way as Example 1. The disk after the texture processing had a surface roughness of 0.26 nm and a number of scratches was 100, i.e., the number of scratches was large.

### Comparative Example 3

By using a staple fiber of an island-in-sea type composite fiber of which island component is the polymer alloy chip of PBT/PLA=40/60 used in Example 6, sea component is the copolymerized polystyrene used in Example 5, island/sea weight ratio =80/20 wt %, number of islands is 36 islands, composite single fiber fineness is 3.5 dtex, cut length is approximately 51 mm and number of crimps is 14 crimps/2.54 cm, a web was prepared through card and crosslapper processes, and then, it was subjected to a needle punch of 4000 needles/cm² by the needle used in Example 1 to thereby prepare a felt having a weight of 700 g/m².

This felt was imparted with 20 wt % polyvinyl alcohol in solid content with respect to the island component by impregnating with a polyvinyl alcohol solution of a liquid temperature of approximately 85° C. and a concentration of approximately 12% and squeezing by nip rolls, and dried. After that, the sea component was removed by 30° C. trichloroethylene and a nonwoven fabric consisting of ultrafine fibers of a single fiber fineness of approximately 0.08 dtex was obtained.

This nonwoven fabric was impregnated with DMF solution of a polyester-polyether-based polyurethane and squeezed by nip rolls to impart with 18 wt % polyurethane in solid content with respect to the fiber weight, and the polyurethane was coagulated by a 30% aqueous solution of DMF of a liquid temperature of 35° C., and the DMF and polyvinyl alcohol were removed by hot water of approximately 85° C. After that, in the same way as Example 1, it was treated with 4% aqueous solution of sodium hydroxide of 80° C. for 30 minutes and dried to dissolve out PLA which is the sea component, to thereby generate ultrafine fibers consisting of PBT. As a result of analyzing the PBT only in this polishing cloth from a TEM picture, the number average single fiber diameter of the PBT was 290 nm (8.6×10⁻⁴ dtex), and, the fiber fineness ratio of single fiber fineness of 1×10⁻⁸ to 1.4×10⁻³ dtex was 68%.

Finally, the surface was buffed by sandpapers in the same way as Example 1 to form raised fibers. The ultrafine fibers on surface were aggregated in a bundle state and not dispersed and it was a surface on which the bundles were raised.

Intersections between the ultrafine fibers were counted by a SEM picture magnified at 2000×, and it was found to be present at 230 places in average in surface area of 0.01 mm², thus, dispersibility was poor.

By using said polishing cloth, a texture processing was carried out in the same way as Example 1. The disk after the texture processing had a surface roughness of 0.49 nm and a number of scratches was 264, i.e., the number of scratches was large.

### Comparative Example 4

N6 of a melt viscosity of 1500 poise (262° C., shear rate 121.6 sec⁻¹) and a melting point of 220° C. and PE of a melt viscosity of 1450 poise (262° C., shear rate 121.6 sec⁻¹) and a melting point 105° C. were mixed by a twin screw extruding mixer at 260° C. while metering respective polymers such that the blend ratio of N6 would be 20 wt % and after being extruded from fine holes at a spinneret temperature of 285° C., it was spun at a spinning speed of 3500 m/min by an ejector, collected on a moving net conveyor, heat press bonded by emboss rolls of a press bond ratio of 16% under a condition of a temperature of 90° C. and a linear pressure of 20 kg/cm, and obtained a long fiber nonwoven fabric of a single fiber fineness 2.0 dtex and a weight of 200 g/m².

The non-woven fabric consisting of said polymer alloy fibers was imparted with an oil agent (SM7060EX produced by Toray Dow Corning Silicone Co. Ltd.) in an amount of 2 wt% with respect to the fiber weight, and 3 sheets of them were superposed, and by subjecting it to a needle punch of 6000 needles/cm² by using a needle with one barb of a depth of 0.06 mm, a non-woven fabric of a weight of 648 g/m² consisting of the polymer alloy fiber was obtained.

This non-woven fabric was imparted with 20 wt % polyvinyl alcohol in solid content with respect to the polymer alloy fiber weight by impregnating with a polyvinyl alcohol solution of a liquid temperature of approximately 85° C. and a concentration of approximately 12% and squeezing by nip rolls, and dried. Next, it was imparted with 18 wt % polyurethane in solid content with respect to the fiber weight by impregnating with DMF solution of a polyester-polyether-based polyurethane and squeezing by nip rolls, and the polyurethane was coagulated by 30% aqueous solution of DMF of a liquid temperature of 35° C., and the DMF and polyvinyl alcohol were removed by hot water of approximately 85° C. After that, the surface was buffed by sandpapers of JIS #240, 320 and 600 to form raised fibers.

Finally, it was treated with toluene of 85° C. for one hour and dried to dissolve out PE which is the sea component, to thereby generate ultrafine fibers consisting of N6. As a result of analyzing the N6 only in this polishing cloth from a TEM picture, ultrafine fibers of a single fiber diameter of 200 nm to 1100 nm (single fiber fineness approximately 4×10⁻⁴ to 1×10⁻² dtex) generated, and number average single fiber diameter of N6 was 517 nm (single fiber fineness 2.4×10⁻³ dtex) of which distribution was large. And, the fiber fineness ratio of single fiber fineness of 1×10⁻⁸ to 1.4×10⁻³ dtex was 12%.

By subjecting it to a crumpling treatment in the jet dyeing machine in said dissolving out process, the polishing cloth was imparted with a physical action, and the ultrafine fibers were dispersed on the polishing cloth surface.

Intersections between the ultrafine fibers were counted by a SEM picture magnified at 2000×, and it was found to be present at 457 places in average in. surface area of 0.01 mm², thus, dispersibility was poor.

By using said polishing cloth, a texture processing was carried out in the same way as Example 1. The disk after the texture processing had a surface roughness of 0.37 nm and a number of scratches of 173, i.e., the number of scratches was large. Characteristics of the obtained polishing cloth are as shown in Table 1, but every of the intersections between the ultrafine fibers in surface area of 0.01 mm² observed from SEM pictures magnified at 2000× of the polishing clothes of Comparative examples 1 to 4, was less than 500 places in average, and the dispersibility was poor. And, hard disks on which a magnetic layer was formed after the texture processing caused errors in hard disk drive test.

[Table 1]

In Table 1, the polishing clothes obtained in Examples 1 to 7 and

Comparative examples 1 to 4 are shown.

[Table 2]

In Table 2, evaluation results of the polishing cloth obtained in Examples 1 to 7 and Comparative examples 1 to 4 are shown.

### INDUSTRIAL APPLICABILITY

The present invention is a polishing cloth obtained by dispersing nanofibers, of which dispersion was very difficult, on surface, and has an extremely dense surface condition and an excellent smoothness which could not be achieved by conventional ultrafine fibers.

For that reason, the present invention can preferably be used as a polishing cloth when, in particular, an aluminum alloy substrate or a glass substrate used for magnetic recording disk is subjected to a texture processing with an ultra high precision finishing.

TABLE 1

| | | | nanofiber | | | | | | |
|---|---|---|---|---|---|---|---|---|---|
| | | | (number average) | | | | | | |
| | island polymer | | | single fiber | distribution | sea polymer | | | |
| | | ratio | diameter | fineness | fiber fineness | | ratio | figure of sheet- | procedure of |
| | polymer | (wt %) | (nm) | (dtex) | ratio (%) | polymer | (wt %) | like material | making ultrafine |
| Example 1 | N6 | 40 | 94 | 7.9 × 10⁻⁵ | 99 | PLA | 60 | long fiber | after raising |
| | | | | | | | | nonwoven fabric | |
| Example 2 | PBT | 20 | 86 | 7.6 × 10⁻⁵ | 99 | PLA | 80 | long fiber | after raising |
| | | | | | | | | nonwoven fabric | |
| Example 3 | N6 | 20 | 58 | 3.0 × 10⁻⁵ | 99 | coplymerized | 80 | staple fiber | after raising |
| | | | | | | PET | | nonwoven fabric | |
| Example 4 | N6 | 40 | 94 | 7.9 × 10⁻⁵ | 99 | PLA | 60 | long fiber | after raising |
| | | | | | | | | nonwoven fabric | |
| Example 5 | N6 | 40 | 320 | 9.2 × 10⁻⁴ | 65 | PLA | 60 | island-in-sea type | after raising |
| | | | | | | | | staple fiber | |
| | | | | | | | | nonwoven fabric | |
| Example 6 | PBT | 40 | 290 | 8.6 × 10⁻⁴ | 68 | PLA | 60 | island-in-sea type | after raising |
| | | | | | | | | staple fiber | |
| | | | | | | | | nonwoven fabric | |
| Example 7 | N6 | 40 | 125 | 1.4 × 10⁻⁴ | 99 | PLA | 60 | long fiber | after raising |
| | | | | | | | | nonwoven fabric | |
| Comparative | N6 | 40 | 94 | 7.9 × 10⁻⁵ | 99 | PLA | 60 | long fiber | after |
| example 1 | | | | | | | | nonwoven fabric | impregnating PU |
| Comparative | N6 | 20 | 58 | 3.0 × 10⁻⁵ | 99 | coplymerized | 80 | staple fiber | after shrinking |
| example 2 | | | | | | PET | | nonwoven fabric | |
| Comparative | PBT | 40 | 290 | 8.6 × 10⁻⁴ | 68 | PLA | 60 | island-in-sea type | after |
| example 3 | | | | | | | | staple fiber | impregnating PU |
| | | | | | | | | nonwoven fabric | |
| Comparative | N6 | 20 | 517 | 2.4 × 10⁻³ | 12 | PE | 80 | long fiber | after raising |
| example 4 | | | | | | | | nonwoven fabric | |

Fiber fineness ratio: a ratio of fibers in the range of single fiber fineness of 1 × 10⁻⁸ to 1.4 × 10⁻³ dtex
N6: Nylon 6
PBT: Polybuthylene terephthalete
PET: Polyethylene terephthalete
PLA: Polylactic acid
PE: Polyethlene
PU: Polyurethane

TABLE 2

| | number of | | texturing of hard disk | |
|---|---|---|---|---|
| | intersections of | dispersibility | surface | number of |
| | ultrafine fiber | of surface | roughness | scratches |
| | (place) | fibers | (nm) | (place) |
| Example 1 | 1295 | good | 0.12 | 15 |
| Example 2 | 1513 | good | 0.17 | 30 |
| Example 3 | 1621 | good | 0.14 | 20 |
| Example 4 | 1295 | good | 0.11 | 10 |
| Example 5 | 1589 | good | 0.18 | 42 |
| Example 6 | 1690 | good | 0.20 | 64 |
| Example 7 | 1053 | good | 0.11 | 13 |
| Comparative | 134 | no good | 0.22 | 105 |
| example 1 | | | | |
| Comparative | 142 | no good | 0.26 | 100 |
| example 2 | | | | |
| Comparative | 230 | no good | 0.49 | 264 |
| example 3 | | | | |
| Comparative | 457 | no good | 0.37 | 173 |
| example 4 | | | | |

1. A polishing cloth comprising ultrafine fibers on its surface, of which a number average single fiber fineness is 1×10⁻⁸ to 1.4×10⁻³ dtex, and a ratio of fibers in the range of a single fiber fineness of 1×10⁻⁸ to 1.4×10⁻³ dtex is 60% or more, wherein intersections between the ultrafine fibers of a single fiber fineness of 1×10⁻⁸ to 1.4×10⁻³ dtex exposed on the surface are present at 500 places or more in average, in 50 places of 0.01 mm² range observed by using a scanning electron microscope (SEM) at 2000× magnification.

2. A polishing cloth according to claim 1, wherein the ultrafine fiber is of a thermoplastic polymer.

3. A polishing cloth according to claim 1 or 2, wherein said ultrafine fiber is a condensation polymerization type polymer.

4. A polishing cloth according to claim 3, wherein said condensation polymerization type polymer is of a polyester or a polyamide.

5. A polishing cloth according to claim 1 or 2, wherein the polishing cloth can be obtained from a long fiber nonwoven fabric produced by a spunbond method.

6. A production method of the polishing cloth of claim 1, wherein by using a molten polymer alloy made by alloying 2 kinds or more of polymers different in solubility to a solvent to form a composite fiber, a composite fiber web is prepared and after subjecting the composite fiber web to an entanglement to prepare a non-woven fabric, a polymeric elastomer is imparted to the non-woven fabric, said polymeric elastomer is substantially coagulated to solidify, and after forming raised fibers on a surface by subjecting to a raising fiber treatment, an ultrafine fiber generation treatment is carried out by dissolving out the easily soluble polymer from said composite fiber.

7. A production method of the polishing cloth according to claim 6, wherein a physical action is imparted in liquid during an ultrafine fiber generation processing or after the generation processing.

8. A polishing cloth according to claim 1, wherein a reinforcing layer is bonded to a back side of the polishing cloth.

9. A polishing cloth according to claim 1, wherein the polishing cloth has a weight per unit area of about 100 to 600 g/m².

10. A method of producing a polishing cloth comprising:
(a) forming polymer alloy fibers by alloying at least two polymers with different solubilities;
(b) preparing a composite fiber web including the polymer alloy fibers;
(c) preparing a non-woven fabric by subjecting the composite fiber web to an entanglement;
(d) imparting a polymeric elastomer to the non-woven fabric and substantially coagulating the polymeric elastomer;
(e) forming raised fibers on a surface of the non-woven fabric; and
(f) performing an ultrafine generation treatment by dissolving out a soluble polymer from the polymer fiber alloys.

11. The method of claim 10 further comprising, after step (c), subjecting the non-woven fabric to one or both of a dry heat or a wet heat treatment.

12. The method of claim 10 further comprising, during or after the ultrafine generation treatment, imparting a physical stimulation in liquid.

13. The method of claim 10 further comprising, before or after the ultrafine generation treatment, subjecting the non-woven fabric to one or both of a dry heat or wet heat treatment.
